(19) United States
(12) Patent Application Publication
(10) Pub. No.: US 2006/0177627 A1
(43) Pub. Date: Aug. 10, 2006

(54) Carrier assembly with fused power and frame-warp aperture

(75) Inventor: William Whitehead, Maryville, TN (US)

Correspondence Address: Stephen B. Salai, Esq.;Harter, Secrest & Emery LLP, 1600 Bausch & Lomb Place, Rochester, NY, 14604-2711, US

(73) Assignee: Schlegel Corporation, New York, NY (US)

(21) Appl. No.: 11/054,485

(22) Filed: Feb. 9, 2005

(51) Int. Cl. B32B 5/12

(52) U.S. Cl. 428/105

(57) ABSTRACT

A carrier assembly is provided for reinforcing vehicle flange engaging strip such as a weatherstrip or trim strip. The carrier assembly includes a serpentine frame and a warp interlaced with the frame to form at least one frame-warp aperture. A fused powder bonds to at least one of the serpentine frame and the warp and inhibits movement of the warp relative to the frame, substantially preserving the frame-warp aperture.

### CROSS-REFERENCE TO RELATED APPLICATIONS

Not applicable.

### STATEMENT REGARDING FEDERALLY SPONSORED RESEARCH OR DEVELOPMENT

Not applicable. REFERENCE TO A “SEQUENCE LISTING”

Not applicable.

### BACKGROUND OF THE INVENTION

1. Field of the Invention

The present invention relates to a carrier assembly for reinforcement of a vehicular strip such as a finishing strip, a trim strip or a sealing strip. More particularly, the present invention relates to a carrier assembly having a serpentine frame, a warp connected to the frame so as to define a frame-warp aperture, wherein movement of the warp relative to the serpentine frame is inhibited by a fused powder on at least one of the frame and the warp, and at least a substantial portion of the frame-warp aperture is preserved.

2. Description of Related Art

Wire carriers are used as a reinforcing frame for extrusion products, such as motor vehicle strips. The wire carriers typically include a continuous wire weft formed into a zig-zag shape with warp threads on the limbs. During manufacture of the motor vehicle strips, the wire carrier is passed through an extruder and is thus subjected to stresses and temperatures which can cause the warp threads to drift laterally, stretch longitudinally and degenerate. Such processing of the wire carrier can result, for example, in breakage of the warps and distortion of the wire carrier which affects the subsequent extrusion process and leads to reduced quality and performance of the resulting vehicular strip. In the forming and extrusion processes, drifting of the warp threads can cause air bubbles and exposure of the wire in the final product. In addition, the shifting of the warp threads can lead to unbalanced locations of the warp threads in the resulting vehicular strip, which can lead to the strip “laying over” upon installation on a vehicle.

In addition, movement of the warp threads during the extrusion process can impart a spiral to the resulting vehicular strip. The tendency of the vehicular strip to spiral significantly hinders installation of the strip on a vehicle. Further, unintended redistribution of the warp threads can lead to a “hungry horse” appearance in the resulting strip as the wire produces corresponding surface features.

There has long been a need to develop a stable wire carrier which overcomes these problems and many attempts have been made without complete success.

EP 038461 3 discloses a knitted wire carrier in which stitched warp threads comprise two threads of polymeric material having different melting points such that when the melting point of the lower melting thread is exceeded the melted thread causes the other thread to be attached to the wire weft. This structure allows single strands of warp thread plied with a meltable filament to be bonded to the wire carrier wherever they are knitted.

U.S. Pat. No. 5,416,961 to Vinay discloses a knitted wire carrier comprising at least one meltable filament laid-in into at least two adjacent warp threads, whereby on heating, the melted filament causes the at least two adjacent warp threads to be bonded to the wire and/or to each other for stabilizing the resulting wire carrier against warp drift.

In spite of these issues, the wire carrier provides substantial benefits. Specifically, the wire carrier exhibits an inherent flexibility about three axes, which in turn provides good handling characteristics of the finished product. Further, in contrast to many stamped metal and lanced and stretched metal carriers, the wire carrier is able to bear relatively high loading, particularly during the extrusion process. In addition, the wire carrier has the benefit of withstanding greater flexing without exhibiting metal fatigue.

Thus, there is a need to develop a stable wire carrier for extruded and molded polymeric products. The need also exists for a carrier assembly with reduced or negligible warp drift, thereby overcoming the problems associated with warp drift.

### BRIEF SUMMARY OF THE INVENTION

The present invention encompasses a carrier assembly with stable and predictable warp locations which provide improved consistency and quality of the carrier assembly and hence improved consistency and quality of any subsequent vehicular strip which incorporates the carrier assembly.

The carrier assembly includes a serpentine frame, a warp extending along the frame, wherein the warp and the serpentine frame define a frame-warp aperture, and a fused powder on at least a portion of one of the frame and the warp. The fused powder impedes movement of the warp relative to the frame and preserves at least a substantial portion of the frame-warp aperture.

The fused powder can be located at a junction of the frame and the warp. In an alternative configuration, the fused powder can be located primarily on the frame. In a further configuration, the fused powder can encapsulate at least a portion of the frame and the warp. In each configuration, at least a substantial portion of the frame-warp aperture is preserved.

In selected configurations, the serpentine frame is formed from a metallic or polymeric material and defines a plurality of limbs interconnected at alternate ends by connecting regions. The warp can include a single or a plurality of threads or yarns interlaced with the limbs of the serpentine frame to define frame-warp apertures.

The fused powder is readily deposited on the serpentine frame and the warp and can be fused to inhibit movement of the warp relative to the frame, and particularly inhibit movement of the warp transverse to a longitudinal dimension of the frame while preserving the frame-warp aperture.

The carrier assembly can be formed by powder coating the serpentine frame and an interlaced warp, interlacing the warp on a powder coated serpentine frame or interlacing a powder coated warp with the serpentine frame.

### BRIEF DESCRIPTION OF THE SEVERAL VIEWS OF THE DRAWING(S)

FIG. 1 is a top plan view of a representative carrier assembly.

FIG. 2 is a cross-sectional view of a vehicular weather strip incorporating a configuration of the carrier assembly.

FIG. 3 is a top plan view of the serpentine frame having parallel limbs.

FIG. 4 is a top plan view of the serpentine frame having curvilinear limbs and connecting regions.

FIG. 5 is a top plan view of the serpentine frame having tapered connecting regions.

FIG. 6 is a top plan view of the serpentine frame having faceted limbs and curvilinear connecting regions.

FIG. 7 is a top plan view of the serpentine frame having a first connecting region configuration along one edge of the frame and a different second connecting region configuration along a second edge of the frame.

FIG. 8 is a top plan view of the serpentine frame having parallel limbs and a plurality warps interlaced with the frame.

FIG. 9 as a top plan view of the serpentine frame having curvilinear shaped limbs and a plurality of warps interlaced with the frame.

FIG. 10 as a top plan view of the serpentine frame having curvilinear shaped limbs and a different configuration of warps interlaced with the frame.

FIG. 11 is an enlarged cross-sectional schematic view showing the fused powder encapsulating a portion of the serpentine frame and the warp.

FIG. 12 is a schematic cross-sectional view of a fused powder on a portion of the serpentine frame engaging a warp.

### DETAILED DESCRIPTION OF THE INVENTION

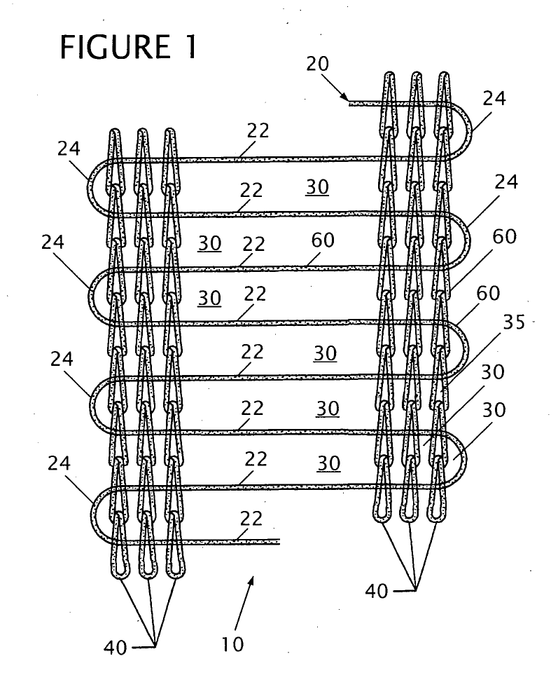

A carrier assembly 10 in accordance with the present invention is shown in FIG. 1. The carrier assembly 10 includes a serpentine frame 20, at least one warp 40 and a fused powder 60 on at least one of the frame and the warp to define at least one frame-warp aperture 30.

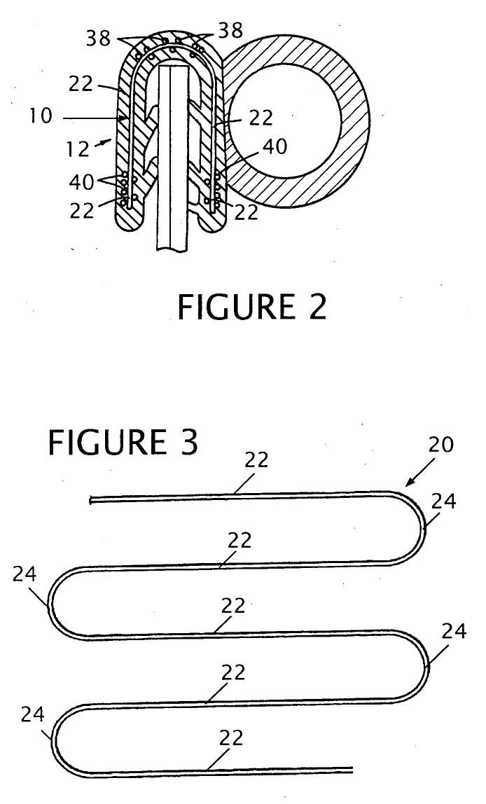

Referring to FIG. 2, the carrier assembly 10 can be incorporated into any of a variety of motor vehicle finishing strips, trim strips or weather strips. A vehicular weatherstrip 12 embedding the carrier assembly 10 is shown in FIG. 2. It is understood the vehicle strips can have any of a variety of configurations for engaging a vehicle, such as a flange engaging strip.

Serpentine Frame

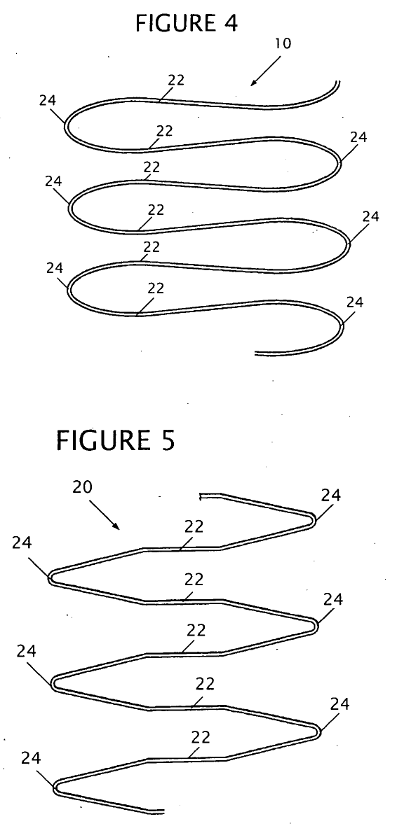

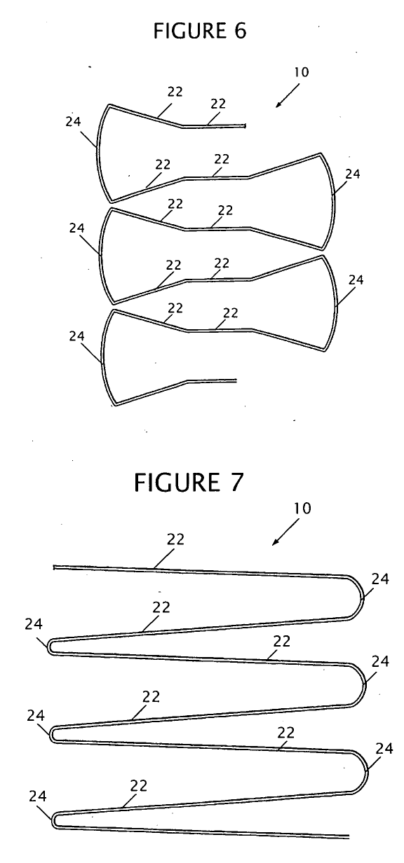

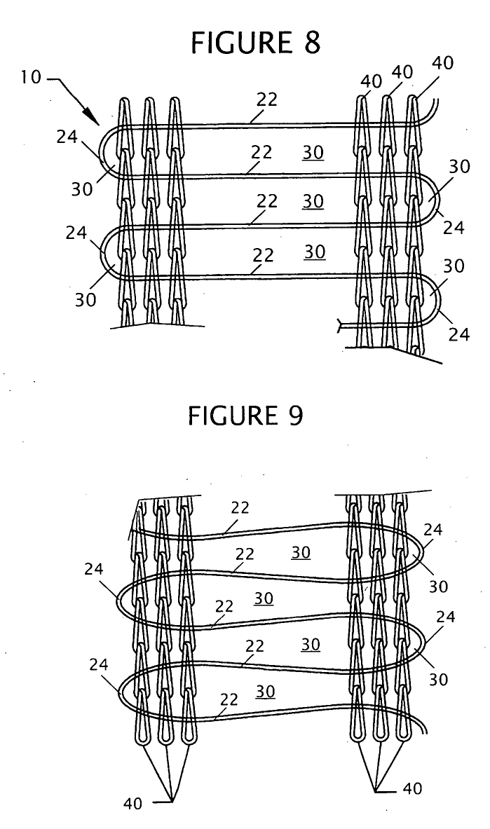

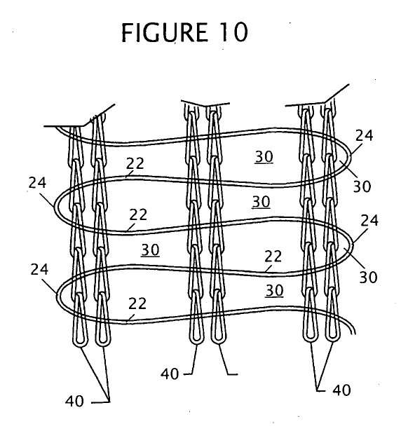

The serpentine frame 20 has a plurality of transversely extending limbs 22 interconnected at alternate ends by connecting regions 24. The limbs 22 can be straight or curvilinear, and can define sections that are linear, faceted, banana shaped, propeller shaped or any combination thereof. The limbs 22 are in a generally parallel relationship, such as adjacent limbs of FIGS. 1, 3 and 8, or alternating limbs are parallel as shown in FIGS. 4-7 and 9-10. The serpentine frame 20 has a width defined by the connecting regions 24 at the end of the limbs 22.

The serpentine frame 20 can be described in terms of the number of limbs 22 per inch (cm) and the length of the limbs. A range for limbs per inch (limbs per cm) is typically from approximately 4 to 12 limbs per inch (1.6 to 4.7 limbs per cm), with a usual range of about 7 to 10 limbs per inch (2.8 to 3.9 limbs per cm), and typical lengths of the limbs (across a width of the carrier assembly 10) range from approximately 0.5 inches (1.3 cm) to approximately 3 inches (7.6 cm).

Although the term “serpentine” frame 20 is used, the serpentine frame is intended to encompass any frame construction, wherein the limbs 22 and connecting regions 24 can have any of a variety of configurations including but not limited to, linear, curvilinear or faceted, wherein a longitudinal dimension of the frame extends generally transverse to the limbs.

The serpentine frame 20 is formed of a filament, or a plurality of filaments having sufficient resiliency to accommodate repeated flexing while having sufficient strength for the filament to retain a downstream formed shape, such as a U-shape transverse to the longitudinal dimension of the serpentine frame. The serpentine frame 20 can be formed of a metallic or non metallic filament. The non metallic filament materials include, but are not limited to plastics, elastomers, polymerics, ceramics or composites. Metallic filament materials include but are not limited to wires, alloys, steel, stainless steel, aluminum, galvanized metals, as well as composites.

For purposes of description, the serpentine frame 20 is set forth in terms of a metallic filament such as wire. However, it is understood, the description is applicable to any type of filament forming the serpentine frame 20.

The thickness of the wire is at least partially determined by the intended operating environment of the resulting strip as well as the configuration of the available extrusion tooling. Typically, the wire has a generally circular cross-section. However, it is understood the wire may have any of a variety of cross-sectional profiles, such as but not limited to obround, elliptical, faceted or triangular.

In one configuration of the wire, the wire has a diameter between approximately 0.010 inches (0.25 mm) and 0.050 inches (1.3 mm), wherein a further construction of the wire has a diameter of approximately 0.018 inches (0.46 mm) to 0.035 inches (0.89 mm). In yet another construction, the wire is a low carbon steel wire or 301 stainless steel having a diameter of about 0.030 inches (0.76 mm).

Referring to FIGS. 1 and 8-10, the warp 40 extends along the longitudinal dimension of the serpentine frame 20. The warp 40 can include a single strand or thread, or multiple strands or threads which can be separate or intertwined. The term “warp” is intended to encompass each of these configurations.

The warp 40 can be secured to the serpentine frame 20 by interlacing, which includes but is not limited to knitting or stitching such as crocheting, sewing, weaving or threading. Referring to FIGS. 1 and 8-10, the frame 20 and the warp 40 define a plurality of frame-warp apertures 30. The frame-warp apertures 30 have a periphery defined by the frame 20 and the warp 40. Depending upon the interlacing of the warp 40 and the frame 20, and the number of warps, the frame-warp apertures 30 can have a variety of sizes. Similarly, there can be a range in the number of frame-warp apertures 30 as defined by the number of limbs 22 per inch (cm), the number of warps 40 and the interlacing configuration.

In one configuration, the warp 40 encompass a portion of the serpentine frame 20 within a crocheted stitch. The warp 40 can be secured to the serpentine frame 20, such as with chain stitching and the warp is pre-tensioned, for example, from approximately 0.5 to 1.0 pounds (0.22 to 0.45 Kg) per warp end, with a satisfactory pre-tensioning of approximately 0.7 pounds (0.32 Kg). It is understood the stitching shown in FIGS. 1 and 8-10, is representative and that the warp 40 can engage the serpentine frame 20 by any of a variety of constructions.

Depending upon the interlacing of the warp 40 with the serpentine frame 20, intra-warp aperture 35 can also be formed as seen in FIG. 1. The intra-warp aperture 35 is defined by the warp 40, rather than the warp and the serpentine frame 20.

The warp 40 can be threads strands, or yarns of any of a variety of materials, such as polymeric materials. The term polymeric is intended to encompass a polymer based on organic or organo-silicone chemistry. The polymer can be a synthetic resin or a natural fiber, such as cotton. Synthetic resins are advantageously more durable and resistant to, although not free from, the stresses incurred during embedding, for example during extrusion of the vehicular strip. Suitable polymeric materials for the warp 40 include, for example polyesters, polypropylenes and nylons, with polyesters being satisfactory. The warp threads have a typical size of about 400 to about 3,000 denier, with a usual size between approximately 800 denier to approximately 2,000 denier.

The fused powder 60 is located on, and bonded to at least one of the serpentine frame 20 and the warp 40. The fused powder 60 impedes or inhibits movement of the warp 40 relative to the serpentine frame 20 (along the transverse direction), thereby reducing warp drift, without the fused powder occluding the frame-warp aperture 30. In one configuration, the fused powder 60 constrains the warp 40 relative to the serpentine frame 20. The resistance to movement of the warp 40 relative to the serpentine frame 20 is created by contact between the warp and the fused powder 60. It is believed the contact between the warp 40 and the fused powder 60 can be created by the fused powder bonding to the serpentine frame 20, the fused powder bonding to the warp, or the fused powder bonding the warp to the serpentine frame.

The amount of contact between the fused powder 60 and the warp 40 is sufficient to reduce or retard movement of the warp relative to the serpentine frame 20, and particularly movement of the warp along a length of the limb 22. The contact between the fused powder 60 and the warp 40 can be provided by the fused powder substantially encapsulating the serpentine frame 20 and the warp 40. Alternatively, the fused powder 60 can be bonded to the serpentine frame 20, such as before the warp 40 is interlaced, and thus contact the warp upon interlacing. It is also contemplated the fused powder 60 can be primarily bonded to the warp 40.

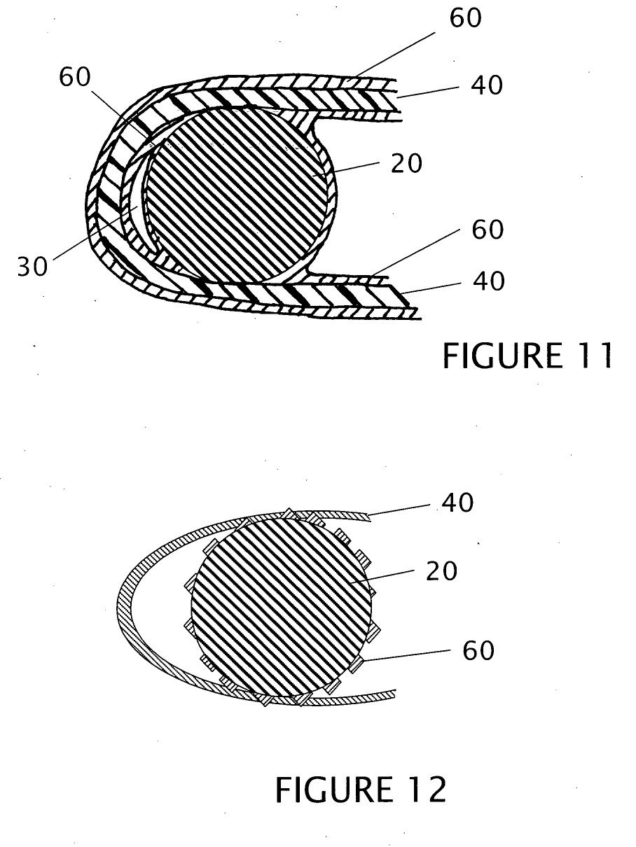

In one configuration, the fused powder 60 is on both the warp 40 and the serpentine frame 20 and effectively locks the warp to a position on the frame. The amount of fused powder 60 can range from the encapsulation of at least a portion of one of the serpentine frame 20 and the warp 40 seen in FIG. 11, to a discontinuous (broken) sputtering seen in FIG. 12. In all configurations, the amount of fused powder 60 is selected to substantially preserve the frame-warp aperture 30.

It is also contemplated the fused powder 60 can be initially located on one of the serpentine frame 20 or the warp 40, and subsequently remelted after interlacing the warp and the frame, so as to bond to both the warp and the frame.

In each configuration of the carrier assembly 10, including the configuration of the fused powder 60 encapsulating at least one of the serpentine frame 20 and the warp 40, at least a percentage of the total number of frame-warp apertures 30 is preserved. That is, the fused powder 60 coats the exposed surfaces of the serpentine frame 20 and the warp 40, without occluding all the frame-warp apertures 30. Typically, at least 50% to 100% of the original number of frame-warp apertures 30 is preserved. It is understood certain configurations of the carrier assembly 10 can preserve as few as 10% of the total number of frame-warp apertures 30. That is, some of the frame-warp apertures 30 can be occluded by the fused powder 60, without blocking all the apertures. The initial area of a given frame-warp aperture 30 and the amount of fused powder 60 are factors in determining the percentage of the original frame-warp apertures 30 that remain after application of the fused powder 60.

Thus, the fused powder 60 can form a portion of the surface of the serpentine frame 20 or of the serpentine frame and the warp 40, wherein at least one frame-warp aperture 30 is substantially preserved. In the encapsulation configuration for a given frame-warp aperture 30, the fused powder 60 slightly extends into the frame-warp aperture, and occludes a portion of the aperture. Typically, at least 80% of the original area of the frame-warp apertures 30 in the carrier assembly 10 is preserved, with configurations of the carrier assembly 10 preserving 10% to 100% of the original area of the apertures. However, depending upon the initial area of the frame-warp aperture 30 and the amount of fused powder 60, a given aperture (or apertures of a certain area or smaller) can be occluded. In such configuration, the remaining frame-warp apertures 30 are of a sufficient area to preclude occlusion, thereby preserving at least one frame-warp aperture.

In a further configuration, the fused powder 60 is bonded to primarily the serpentine frame 20, with a minimal or insignificant amount of powder bonded to the warp 40. In this configuration, the fused powder 60 forms a rough surface on the serpentine frame 20, as seen in FIG. 12, and does not encapsulate the frame, but rather forms local discontinuities or areas of fused powder. The roughness imparted by the fused powder 60 is sufficient to inhibit or impede lateral movement of the warp 40 relative to the serpentine frame 20 and limb 22. Typically, such roughness is less than the diameter of the warp 40. Thus, for example, the fused powder 60 can create a surface roughness on the order of approximately 0.001 inches (0.0025 cm) to 0.010 inches (0.0254 cm). In this configuration, the fused powder 60 preserves a majority of the frame-warp apertures 30, and in certain constructions maintains over 90% of the total number of frame-warp apertures 30 and over 90% of the initial area of the frame-warp apertures of the carrier assembly 10.

Thus, a percentage of the total number of initial frame-warp apertures 30 and a percentage of the initial total area of the frame-warp apertures are preserved. Depending upon the configuration of the serpentine frame 20, the warp 40 and the fused powder 60, any of a variety of combinations of preserved number of frame-warp apertures 30 or preserved area of the frame-warp apertures can be provided.

Powders

The fused powder 60 can be a thermoplastic or thermoset. The thermoplastic powders do not chemically react in a heat phase, but rather soften and then re-solidify upon reduction of the temperature. Thermoset powders are applied and then cured, inducing a chemical cross-linking, thereby changing the fused powder 60 into a form that will not remelt.

The powders to be fused can be formulated to meet a variety of performance characteristics, including thickness, texture, color, hardness, chemical resistance, UV resistance or temperature resistance. The particle size of the powder can also be controlled in response to the desired performance of the fused powder 60.

A representative thermoplastic powder is polyethylene, having a melting point below a melting point of the serpentine frame 20 and the warp 40. In one configuration, the thermoplastic powder has a melting point of approximately 120° C.

A thermoset powder includes a thermosetting resin and a curing, or cross linking agent. A thermosetting resin for the fused powder can include epoxy resins, acrylic resins, phenol resins and polyester resins. These thermosetting resins can be used alone, or combined together with other resins. In particular, a thermosetting resin having an epoxy group (that is, glycidyl group), such as epoxy resins, acrylic resins are available. These thermosetting resins have excellent reactivity to a curing agent, even at relatively low temperatures, for example, approximately 120° C.

A latent curing agent such as dicyandiamide, imidazolines, hydrazines, acid anhydrides, blocked isocyanates, and dibasic acids can be added to the resin particles as a curing promoter. The latent curing agent is typically stable at room temperature, and crosslinks with a thermosetting resin in a range of 140° C. to 260° C. It is understood any of a variety of cross-linking agents can be employed.

For thermoplastic or thermoset powders, an additive or a functional material can be added to the resin particles, such as a filler including calcium carbonate, barium sulfate or talc; a thickener, for example silica, alumina or aluminum hydroxide; a pigment including titanium oxide, carbon black, iron oxide, copper phthalocyanine, azo pigments or condensed polycyclic pigments; a flowing agent such as silicone or acrylic oligomer, for example butyl polyacrylate; an accelerating agent such as zinc compounds; a wax such as polyolefin; a coupling agent including silane coupling; an antioxidant; or even an antimicrobial agent.

Suitable powders to be fused are sold by Morton Powder Coating of Warsaw, Ind. and include DG-5001 CORVEL® BLUE (ethylene/Acrylic), DG-7001 CORVEL® BLACK 20 (Ethylene/Acrylic), 78-7001 CORVEL® BLACK (Nylon) and 70-2006 CORVEL® YELLOW (Nylon).

It is also contemplated the fused powder 60 can be selected to promote bonding with the embedding material of the subsequent vehicular strip 12. In such configurations, the powder includes a methacrylate coagent or a maleate.

Thus, the fused powder 60 can be constructed to retain the warp 40 relative to the serpentine frame 20, preserve the frame-warp aperture 30, bond to the embedding material of the vehicular strip 12 and insulate the frame.

The fused powder 60 is formed by retaining unfused powder on one of the serpentine frame 20 and the warp 40, and then fusing the powder. The powder can be temporarily disposed on the one of the serpentine frame 20 and the warp 40 by a variety of mechanisms including bonding agents, friction adhesion, or electrostatic attraction.

The bonding agents can be incorporated into the powder, or applied to the one of the serpentine frame 20 and the warp 40 in a desired location for the fused powder 60 prior to exposure of the frame and the warp to the powder.

Alternatively, a surface charge is formed on the one of the serpentine frame 20 and the warp 40, and the powder is oppositely charged, such that upon exposure of the oppositely charged powder to the surface charged portions of one of the frame and the warp, the powder is temporarily adhered.

To form the necessary surface charge on the one of the serpentine frame 20 and the warp 40, a potential is applied to the frame. It has been found that a sufficient potential can be applied to the serpentine frame 20 to create a charge sufficient to retain the powder prior to fusing.

By controlling the amount of powder exposed to the electrical potential difference between the powder and the surface charge on the one of the serpentine frame 20 and the warp 40, the amount of powder retained on the one of the serpentine frame 20 and the warp 40 can be controlled. As the amount of retained powder on the one of the serpentine frame 20 and the warp 40 at least partially determines the thickness of the fused powder 60, the thickness of the fused powder can thus be controlled.

Alternatively, the serpentine frame 20 and the warp 40 can be passed through a bath, or fluidized bed of the powder to deposit the powder on the frame and the warp. The powdered serpentine frame 20 and warp 40 can then be subject to a controlled vibration or air jet to remove excess powder. Alternatively, the powder can be vibrated with the serpentine frame 20 and the warp 40 to deposit the powder. It is further contemplated that rollers can be used to deposit the powder on the serpentine frame 20 and the warp 40.

Further mechanisms for depositing the powder onto the serpentine frame 20 and the warp 40 include sprinkling the powder onto the frame and the warp, or passing the frame and the warp through a curtain of the powder. It is also contemplated the powder can be sprayed onto the serpentine frame 20 and the warp 40. The spray method can also involve imparting a charge to the powder, which is then electrostatically attracted to one of the serpentine frame 20 and the warp 40. Alternatively, a contact device, such as a roller can also be employed to deposit the powder onto the frame 20 and the warp 40.

The temporarily retained or adhered powder is then melted and bonded to the serpentine frame 20 by a variety of options including radiative, convective, inductive or conductive heating. The bonding of the fused powder 60 to the serpentine frame 20 or the warp 40 is sufficient to inhibit movement of the warp relative to the limb 22.

The heating can be accomplished in a processing line downstream of the knitter (which formed the interlaced warp 40 and the serpentine frame 20) and a finished carrier assembly 10 take-up apparatus. Heating above the melting point of the meltable (or curable) powder causes the powder to bond to the serpentine frame 20 and/or the warp 40. On cooling, the melted powder hardens and the warp 40 is bonded in position. In one configuration, the warp 40 is bonded to the serpentine frame 20 and locked in a given position. In a different configuration, the fused powder 60 forms the roughened surface on the serpentine frame 20 which engage the warp 40. The carrier assembly 10 has a flat profile, is longitudinally stable and is virtually free of warp drift.

Heating of the frame, the warp and the powder can be accomplished by a variety of methods which allow the powder to be heated close to or above the melting point of the powder. In one configuration, the heating above the melting point of the meltable powder is carried out for a period of time sufficient to cause the melted powder to at least partially flow about the junction of the warp 40 and the serpentine frame 20. Generally, the heating of the serpentine frame 20, the warp 40 and the powder can be accomplished by conductive, inductive, convective or radiative heating such as infrared, hot air or microwave. One method of heating includes exposing the serpentine frame 20, the warp 40 and the powder to a flow of heated air in an oven to fuse the powder without fusing or melting the warp. Another method comprises heating the serpentine frame 20, the warp 40 and the powder with infra-red radiation. A further method comprises passing the serpentine frame 20, the warp 40 and the powder over a heated roller. Another method contemplates induction heating of the serpentine frame 20. In yet another configuration, the heated serpentine frame 20, the warp 40 and the powder are passed between forming rolls. The roll treatment can also help to maintain the flat profile of the carrier assembly 10. The roll forming treatment can be applied during the heating process or immediately after the powder is fused.

Cooling of the carrier assembly 10 is accomplished by exposure to cooling jets or streams which can include air jets or ambient temperatures for a period of time after pulling the carrier assembly from the heater.

In contrast to powder coating the serpentine frame 20 interlaced with the warp 40, it is contemplated the fused powder 60 can be bonded to the filament prior to interlacing the warp 40. That is, the fused powder 60 is bonded to the filament, and the coated filament is formed into the serpentine frame and interlaced with the warp 40. The fused powder 60 thus mechanically engages the warp 40 and bonds to the serpentine frame 20.

In a further configuration, it is contemplated the fused powder 60 can be bonded to the warp 40 prior to interlacing with the filament.

Therefore, the process can include powder coating the serpentine frame 20 and the interlaced warp 40, interlacing the warp with a powder coated serpentine frame or interlacing a powder coated warp with the serpentine frame.

It is further contemplated that for thermoplastic fused powders 60 on one of the filament or the warp 40 prior to interlacing, the fused powder can be reheated after interlacing to induce the powder to fuse bond to the remaining component.

The invention provides a strong, physically and chemically stable carrier assembly 10, essentially free of warp drift which allows close grouping and selective positioning of adjacent warp 40, and allows grouping and bonding of different numbers of adjacent warps. Warp damage is minimized in the subsequent extrusion coating processes and, overall, greater control of the profile, appearance and quality of the product is achieved. The present process uses existing knitting equipment with a minimum of modification and is effective in reducing manufacturing costs.

It is also contemplated the amount of fused powder 60 can be selected to reduce or minimize de-spragging of the carrier assembly 10. That is, absent the fused powder 60, upon cutting the serpentine frame 20, the free end of the serpentine frame 20 (the filament) tends to straighten and can form an undesirable projection which can interfere with subsequent operator and machine handling of the carrier assembly 10. It is believed the fused powder 60 can provide sufficient retentive force on the carrier assembly 10 to substantially preclude the free end of the serpentine frame 20 (the filament) pulling from the warp 40. Thus, the previously required step of de-spragging the cut carrier assembly 10 is obviated.

In addition, it is believed the fused powder 60 on the warp 40 reduces a tendency of the warp to fluff or fray upon the carrier assembly 10 (and the warp) being cut to length. Reducing the fluff of the cut warp 40 reduces the tendency of the carrier assembly 10 (and the warp) to absorb moisture, and improves subsequent embedding of the carrier assembly, thereby providing a more satisfactory finished product.

The carrier assembly 10 is particularly useful as reinforcement for elastomeric (polymeric) vehicular strip 12 for example, flange engaging strips including trunk seals, door seals or edge protector strips as well as glass run channels, and sun roof seals. The carrier assembly 10 is advantageous for extrusion processes due to the control or virtual absence of warp drift and longitudinal stability under the conditions of the extrusion process. The carrier assembly 10 provides for positioning of the warp 40 or warps, at the parts of the strip requiring the most reinforcement, for example, the base or the sides of a subsequently formed U-shape channel.

In subsequent formation of the vehicular strip 12 the preserved frame-warp aperture 30 is filled by the embedding material of the strip during a conventional extrusion or molding processes. The material embedding the carrier assembly 10 is typically a polymeric material, such as for example, a thermoplastic or thermosetting elastomer. Generally, the carrier assembly 10 is fed through an extruder, wherein a polymeric material is extruded about the carrier assembly 10 so as to embed the carrier assembly within the polymeric material. To provide satisfactory embedding of the carrier assembly 10, the embedding material must “strike through” the frame-warp aperture 30. That is, the embedding material must flow through the frame-warp aperture 30, thereby entirely embedding the cross section of the carrier assembly 10.

While the invention has been described in conjunction with specific embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

1. A carrier assembly, comprising:
(a) a serpentine frame;
(b) a warp extending along the frame and defining at least one frame-warp aperture; and
(c) a fused powder on at least a portion of one of the frame and the warp, the fused powder impeding movement of the warp relative to the frame and substantially preserving the frame-warp aperture

2. The carrier assembly of claim 1, wherein the fused powder is located on a junction of the frame and the warp.

3. The carrier assembly of claim 1, wherein the fused powder is substantially located on the frame.

4. The carrier assembly of claim 1, further comprising a strip body embedding the fused powder, the frame and the warp, the strip body substantially filling the frame-warp aperture.

5. The carrier assembly of claim 4, wherein the strip body is a flange engaging strip,

6. The carrier assembly of claim 4, wherein the strip body is a weatherstrip.

7. The carrier assembly of claim 4, wherein the strip body is an edge strip.

8. The carrier assembly of claim 4, wherein the strip body includes at least one of a thermoplastic and a thermoset.

9. The carrier assembly of claim 1, wherein the fused powder encapsulates at least one of the frame and the warp.

10. The carrier assembly of claim 1, wherein the frame is metal.

11. The carrier assembly of claim 1, wherein the frame is polymeric.

12. The carrier assembly of claim 1, wherein the fused powder forms a discontinuous surface.

13. The carrier assembly of claim 1, wherein the fused powder forms a discontinuous surface on the serpentine frame

14. The carrier assembly of claim 1, wherein the fused powder forms a discontinuous surface on the warp.

15. The carrier assembly of claim 1, wherein the fused powder forms a roughened surface on the serpentine frame.

16. The carrier assembly of claim 1, wherein the serpentine frame includes a plurality of limbs interconnected at alternate ends by connecting regions, and the warp extends transverse to the limbs along a longitudinal dimension of the serpentine frame.

17. The carrier assembly of claim 16, wherein the connecting regions are linear

18. The carrier assembly of claim 16, wherein the connecting regions are curvilinear.

19. The carrier assembly of claim 16, wherein the connecting regions are faceted.

20. The carrier assembly of claim 16, wherein the limbs include an inflection point.

21. The carrier assembly of claim 16, wherein the limbs are curvilinear.

22. The carrier assembly of claim 16, wherein the limbs are linear.

23. The carrier assembly of claim 1, wherein the warp is interlaced with the frame.

24. The carrier assembly of claim 23, wherein the warp is knitted to the frame.

25. The carrier assembly of claim 23, wherein the warp is woven into the frame.

26. The carrier assembly of claim 23, wherein the warp is crocheted to the frame.

27. The carrier assembly of claim 1, wherein the fused powder includes one of a thermoplastic and a thermoset.

28. The carrier assembly of claim 1, wherein the fused powder is bonded to the one of the frame and the warp.

29. A method of forming a carrier assembly, the method comprising fusing a powder to at least one of a serpentine frame and a warp to inhibit movement of the warp relative to the frame and substantially preserve a frame-warp aperture.

30. The method of claim 29, further comprising embedding the fused powder frame and warp in a strip material to substantially the frame-warp aperture.

31. The method of claim 29, further comprising employing a flowable material as the powder.

32. The method of claim 29, further comprising employing a particulate material as the powder.

33. The method of claim 29, further comprising interlacing the warp to the frame.

34. The method of claim 29, further comprising knitting the warp to the frame.

35. The method of claim 29, further comprising weaving the warp to the frame.

36. The method of claim 29, further comprising crocheting the warp to the frame.

37. The method of claim 29, further comprising heat fusing the powder to a junction of the frame and the warp.

38. The method of claim 29, further comprising fusing a sufficient amount of powder to at least partially coat the frame and the warp.

39. The method of claim 29, further comprising forming the frame with a plurality of limbs interconnected at alternate ends by connecting regions, and the warp extends transverse to the limbs along a longitudinal dimension of the serpentine frame.

40. The method of claim 39, further comprising forming the interconnecting regions as linear.

41. The method of claim 39, further comprising forming the interconnecting regions as curvilinear.

42. The method of claim 39, further comprising forming the interconnecting regions as segmented.

43. The method of claim 39, further comprising forming the limbs to include an inflection point.

44. The method of claim 39, further comprising forming the limbs to be linear.

45. The method of claim 39, further comprising forming the limbs to be curvilinear.

46. Amended) The method of claim 29, further comprising forming the powder of one of a thermoplastic and a thermoset.

47. The method of claim 29, further comprising fusing the powder to form a discontinuous surface on the serpentine frame.

48. The method of claim 29, further comprising fusing the powder to form a discontinuous surface on the warp.
